(19) United States
(12) Patent Application Publication
(10) Pub. No.: US 2007/0127521 A1
(43) Pub. Date: Jun. 7, 2007

(54) INTERFACE BETWEEN NETWORK DATA BUS APPLICATION AND AVIONICS DATA BUS

(75) Inventors: Gordon R. Sandell, Bothell, WA (US); Charles A. Curtin, Woodinville, WA (US); Stephen Y. Lee, Shoreline, WA (US)

Correspondence Address: LEE & HAYES, PLLC, 421 W. RIVERSIDE AVE., SUITE 500, SPOKANE, WA, 99201, US

(73) Assignee: THE BOEING COMPANY, Chicago, IL (US)

(21) Appl. No.: 11/554,966

(22) Filed: Oct. 31, 2006

Related U.S. Application Data
(60) Provisional application No. 60/741,635, filed on Dec. 2, 2005.

(51) Int. Cl. H04J 3/16

(52) U.S. Cl. 370/466; 370/473

(57) ABSTRACT

A method for transmitting data between a first device and second device is disclosed. The method includes receiving a block of data; dividing the block of data into at least a first packet having a first size and a second packet having a second packet size; transmitting the first packet to a converter, the converter being configured to convert a packet from a first communication protocol to a second communication protocol; and transmitting the second packet to the converter after waiting a predetermined time. The first packet size, the second packet size, and the predetermined time are selected to prevent overflow of a memory of the converter. The second packet size, and the predetermined time are selected to prevent expiration of a timer at the second data bus. The time is associated with data transferred in the first and second packets.

### CROSS-REFERENCE TO RELATED APPLICATIONS

This application claims the benefit U.S. Provisional Application No. 60/741,635, filed Dec. 2, 2005.

### BACKGROUND OF THE INVENTION

1. Field of the Invention

The invention relates to the systems, devices and methods used to interface between different networks having different transport protocols and, more particularly, to systems, devices, and methods that interface between devices connected to network data buses, including Ethernet or Avionics Full Duplex (AFDX) data buses, and devices connected to avionics data buses, including ARINC 429 data buses.

2. Description of the Related Art

The ARINC 429 standard was developed by the aviation industry as a standard communication protocol for point-to-point data bus communication. As ARINC 429 systems developed, the Williamsburg file transfer protocols, defined in ARINC 429P3-18, were developed to transfer files larger that 32 bit words. Thus, in these latter systems, data was transferred using Williamsburg over ARINC 429.

In contrast, Ethernet data buses and associated standard communication protocols were developed by the computer industry to interconnect computers. Ethernet provides for higher data rates and accommodates larger file sizes. However, due to different development paths, Ethernet devices are not directly compatible with ARINC 429 devices.

Consequently, as avionics system designs migrate from the traditional federated systems using point-to-point data buses (ARINC 429) to an Integrated Modular Avionics (IMA) using networked data buses, such as the Avionics Full Duplex (AFDX) data bus or Ethernet, the need arises to interface the legacy equipment that uses the old point-to-point data bus with devices connected to the Ethernet bus. This interface avoids the need for costly redevelopment or replacement of the legacy equipment.

### BRIEF SUMMARY OF THE INVENTION

The present invention addresses the problems identified above by providing methods, equipment and systems that can provide an interface between avionics equipment connected to avionics data buses, such as ARINC 429 compatible devices, and devices connected to network data buses, such as Ethernet or AFDX networks.

One embodiment of this invention allows an application on a networked data bus to interface to an end system that uses the Williamsburg file data transfer protocols (versions 1 and 3, as defined in ARINC 429P3-18) over an ARINC 429 data bus.

Another embodiment provides for using an AFDX data bus to transfer files to an ARINC 429 end system by transmitting the protocol and data words required for a Williamsburg (Version 1 or 3) file transfer in the scheduled AFDX data blocks between the application and a Remote Data Concentrator (RDC) and using an ARINC 429 data bus between the RDC and the legacy end system.

Another embodiment provides for using an AFDX data bus to receive files from an ARINC 429 end system by transmitting the protocol and data words required for a Williamsburg (Version 1 or 3) file transfer in the scheduled AFDX data blocks between the application and an RDC and using an ARINC 429 data bus between the RDC and the legacy end system.

Another embodiment provides for transmitting data between an Ethernet device and an ARINC 429 device. The method includes receiving a block of data; dividing the block of data into Ethernet packets, the Ethernet packets comprising at least a first packet and a second packet, the first packet having a first packet size and the second packet having a second packet size; transmitting the first packet; and transmitting the second packet after waiting a predetermined time. The first packet size, the second packet size, and the predetermined time are selected to prevent buffer or memory overflow at an Ethernet to ARINC 429 data converter. The second packet size, and the predetermined time are selected to prevent expiration of a timer at the ARINC 429 device. And the timer is associated with data transferred in the first and second packets.

Another embodiment provides for transmitting data between an Ethernet device and at least first and second ARINC 429 devices. The method includes receiving a first block of data addressed to the first ARINC 429 device; receiving a second block of data addressed to the second ARINC 429 device; dividing the first block of data into Ethernet packets, the Ethernet packets comprising at least a first packet and a second packet, the first packet having a first packet size and the second packet having a second packet size; dividing the second block of data into Ethernet packets, the Ethernet packets comprising at least a third packet and a fourth packet, the third packet having a third packet size and the fourth packet having a fourth packet size; transmitting the first packet addressed to the first ARINC 429 device; transmitting the third packet addressed to the second ARINC 429 device; transmitting the second packet addressed to the first ARINC 429 device after waiting a first predetermined time, and transmitting the fourth packet addressed to the second ARINC 429 device after waiting a second predetermined time. The first packet size, the second packet size, and the first predetermined time are selected to prevent buffer or memory overflow at a first Ethernet to ARINC 429 data converter. The second packet size, and the first predetermined time are selected to prevent expiration of a first timer at the first ARINC 429 device. The first timer is associated with data transferred in the first and second packets. The third packet size, the fourth packet size, and the second predetermined time are selected to prevent buffer or memory overflow at a second Ethernet to ARINC 429 data converter. The fourth packet size, and the second predetermined time are selected to prevent expiration of a second timer at the second ARINC 429 device. And the second timer is associated with data transferred in the third and fourth packets.

Another embodiment provides a method for transmitting data between a first device connected to first data bus having a first communication protocol and second device connected to a second data bus having a second communication protocol. The method includes receiving a block of data; dividing the block of data into at least a first packet having a first packet size and a second packet having a second packet size; transmitting the first packet to a converter, the converter being configured to convert a packet from the first communication protocol to the second communication protocol; and transmitting the second packet to the converter after waiting a predetermined time. The first packet size, the second packet size, and the predetermined time are selected to prevent overflow of a memory of the converter. The second packet size, and the predetermined time are selected to prevent expiration of a timer at the second data bus. The time is associated with data transferred in the first and second packets.

A further embodiment of the invention provides a device for transmitting data between a first device connected to first data bus having a first communication protocol and second device connected to a second data bus having a second communication protocol. A receiver receives a block of data. A divider divides the block of data into at least a first packet and a second packet, the first packet having a first packet size and the second packet having a second packet size. A transmiter transmits the first packet to a converter, the converter being configured to convert a packet from the first communication protocol to the second communication protocol. A transmiter transmits the second packet to the converter after waiting a predetermined time. The first packet size, the second packet size, and the predetermined time are selected to prevent buffer or memory overflow at the data converter. The second packet size, and the predetermined time are selected to prevent expiration of a timer at the second device. The timer is associated with data transferred in the first and second packets.

### BRIEF DESCRIPTION OF THE DRAWINGS

The accompanying drawings incorporated in and forming part of the specification illustrate several aspects of the present invention. In the drawings:

FIG. 1 illustrates using an embodiment of the present invention to connect an Ethernet device to multiple ARINC 429 devices.

FIG. 2 is one embodiment of a functional diagram showing an ARINC 429 device connected to an Ethernet device over an Ethernet bus for one of the connections shown in FIG. 1.

FIG. 3 shows an example of a timing chart in one embodiment of the invention.

FIG. 4 illustrates an example of dividing one or more files into ARINC 429 words.

Reference will now be made in detail to various embodiments of the invention, examples of which are illustrated in the accompanying drawings.

### DETAILED DESCRIPTION

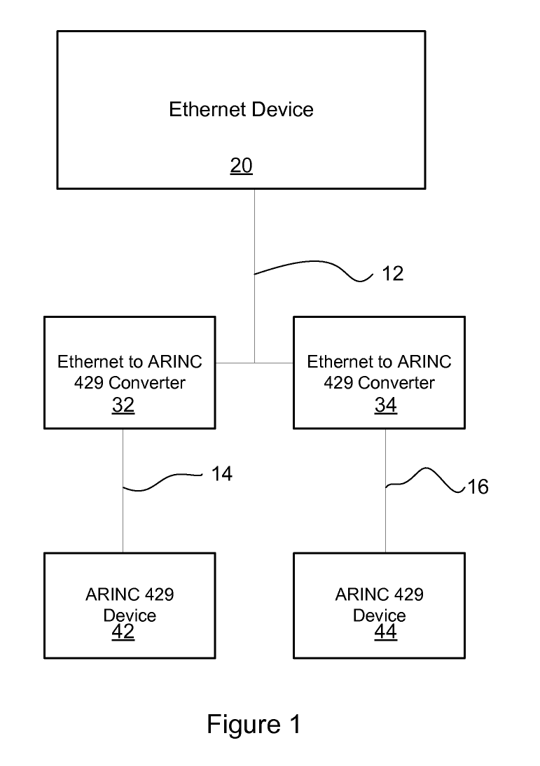

The present invention relates to systems and methods for interfacing between network data bus applications and avionics data buses. Many specific details of certain embodiments of the invention are set forth in the following description and in FIGS. 1-4 to provide a thorough understanding of such embodiments. One skilled in the art, however, will understand that the present invention may have additional embodiments, or that the present invention may be practiced without several of the details described in the following description.

In the following detailed description, references are made to various specific embodiments of avionics data buses, such as a current industry-standard data bus known as the ARINC 664 (AFDX), and to specific embodiments of general network data buses, such as the widely-used Ethernet data buses. Such references to specific embodiments of data buses are made for the sake of brevity and to improve a reader's understanding of the invention through a discussion of specific embodiments of the invention. It should be appreciated, however, that the invention is not limited to these specific embodiments of data buses, and that alternate embodiments of the invention may be conceived that operate with various other types and models of data buses.

The AFDX data bus is described by ARINC 664, and is generally described as an Ethernet bus in which all data is scheduled for transmission. This provides a guarantee that data will be transmitted between systems within a specified time. To achieve this, each system is limited in the size of the message it will transmit, and the period that it will be scheduled for transmission. The ARINC 664 standard is herein incorporated by reference.

The Williamsburg file transfer protocol is described by ARINC 429P3. This protocol provides for block data transfer over a periodic data bus. This protocol is used by many legacy avionics systems, especially equipment used for datalink communications. Version 1 of the Williamsburg file transfer protocol allows for transmission of up to 65000 32 bit words, and also dictates timers and counters that must be used for successful communication. ARINC 429 will operate at bus speeds of up to 100 Kbps. The ARINC 429 standard is herein incorporated by reference.

FIG. 1 illustrates a system 10 that provides data communication between an Ethernet device 20 and ARINC devices 42, 44 using Ethernet to ARINC 429 converters 32, 34. The Ethernet to ARINC 429 converter may also be referred to as a remote data concentrator (RDC). The Ethernet device 20 communicates with Ethernet to ARINC 429 converters 32, 34 over an Ethernet network or bus 12. Ethernet to ARINC 429 converters 32, 34 communicate with ARINC 429 devices 42, 44 over ARINC 429 buses 14, 16. Typically, each bus 14, 16 has both a transmit bus and a receive bus. However, other embodiments the transmit bus and receive bus may share a single bus or connection.

Each remote data concentrator (RDC) or Ethernet to ARINC 429 converter 32, 34 provides a gateway function between the AFDX or Ethernet bus 12 and ARINC 429 buses 42, 44 that operate asynchronously. To optimize cost, size, and power constraints, an Ethernet to ARINC 429 converter may be designed with memory and throughput that may not support the data capacity required for Williamsburg data. ARINC 429 bus transmits at a fixed rate. Therefore, the filling of Ethernet to ARINC 429 converter memory may be managed based on the known rate of data outflow.

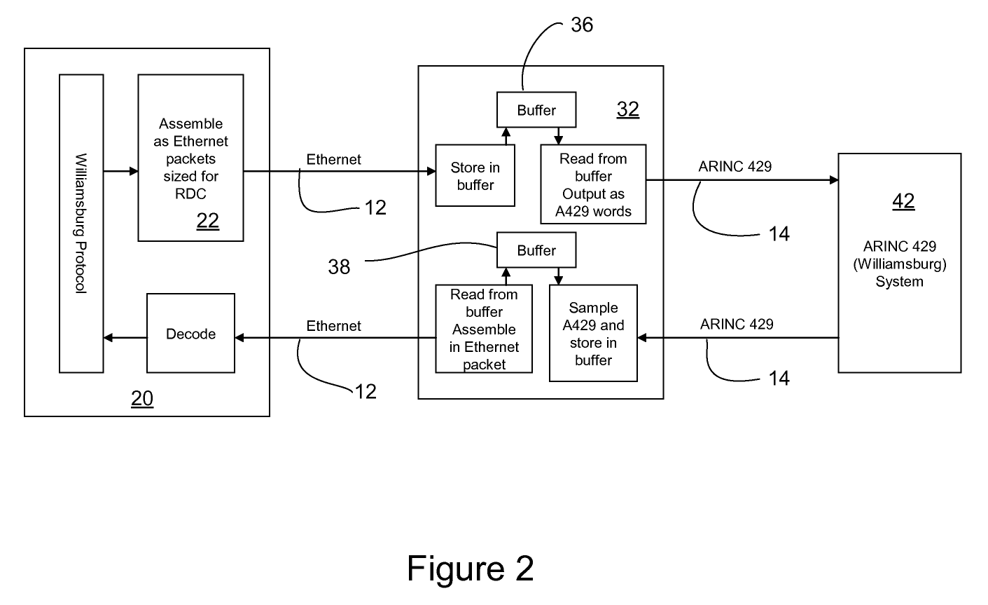

FIG. 2 illustrates the connections and data flow between the Ethernet device 20 and one ARINC 429 device 42 via the Ethernet to ARINC 429 converter 32. Connections and data flow with other ARINC 429 devices may be similar.

As shown in FIG. 2, one embodiment of the invention includes a software application 22 that is hosted on an AFDX architecture or Ethernet device 20 to communicate with a legacy ARINC 429 system 42 via an Ethernet to ARINC 429 converter 32 or RDC that may have a limited memory and throughput capability. The software application (programming instructions) 22 may be stored on any current or future memory. The memory may be fixed or removable. In another embodiment a dedicated ASIC may be used instead of software.

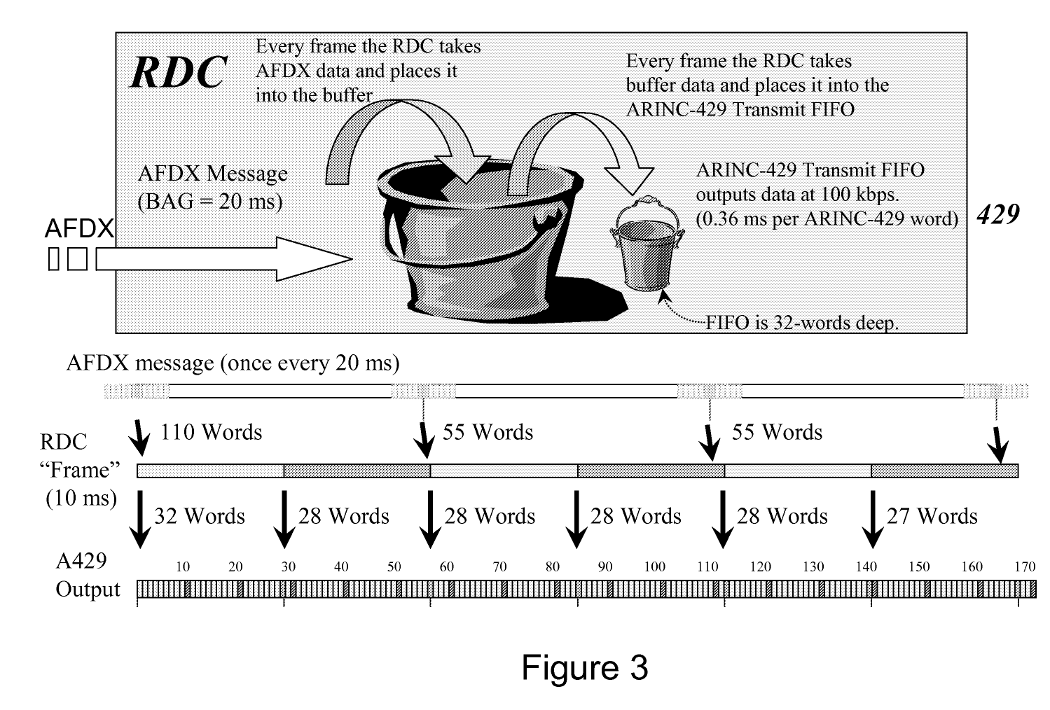

In one embodiment, the transmit data rate occurs at a rate fast enough to not allow a buffer 36 or memory in the Ethernet to ARINC 429 converter 32 or RDC to become empty, without overflowing it. Failure to keep data available in the memory may result in overrunning of the Williamsburg timers, and a breakdown in communication. One example of an Ethernet data transmit rate used in one preferred embodiment is shown in FIG. 3. In other embodiments, the buffer 36 may be allowed to empty so long as the Williamsburg timers in the ARINC 429 device do not expire or overrun. Overflowing the memory buffers will cause loss of data.

The rate of transmission of and response to Williamsburg messages (e.g. request to send clear to send, etc.) should be sufficient to satisfy the Williamsburg response timers. Thus, in some embodiments, data transmission is scheduled on the Ethernet or AFDX bus to satisfy the most stringent Williamsburg timer, which is the RTS (Request To Send) to CTS (Clear To Send) response time. In other embodiments, the data transmission is scheduled on the Ethernet or AFDX bus to satisfy the Williamsburg timer response time associated with the data transmission. In embodiments where transmissions are not scheduled, the priority of the data transmission is set so that the Williamsburg timer response time associated with the data transmission is satisfied.

When the data block transmitted from the Ethernet device 20 is larger than a predetermined size, the data block may be sized to manage the amount of data in the buffer 36 of the Ethernet to ARINC 429 converter 32 or in the RDC memory. The sizing may be accomplished by segmenting a file into multiple Ethernet or AFDX messages. If the data block size is smaller than the predetermined size the data block may be transmitted in a single message. When the data block size is equal to or larger than the predetermined size the data block may be transmitted in two or more messages. The predetermined size may be based on the memory and/or buffer size of the Ethernet to ARINC 429 converter 32 or in the RDC memory.

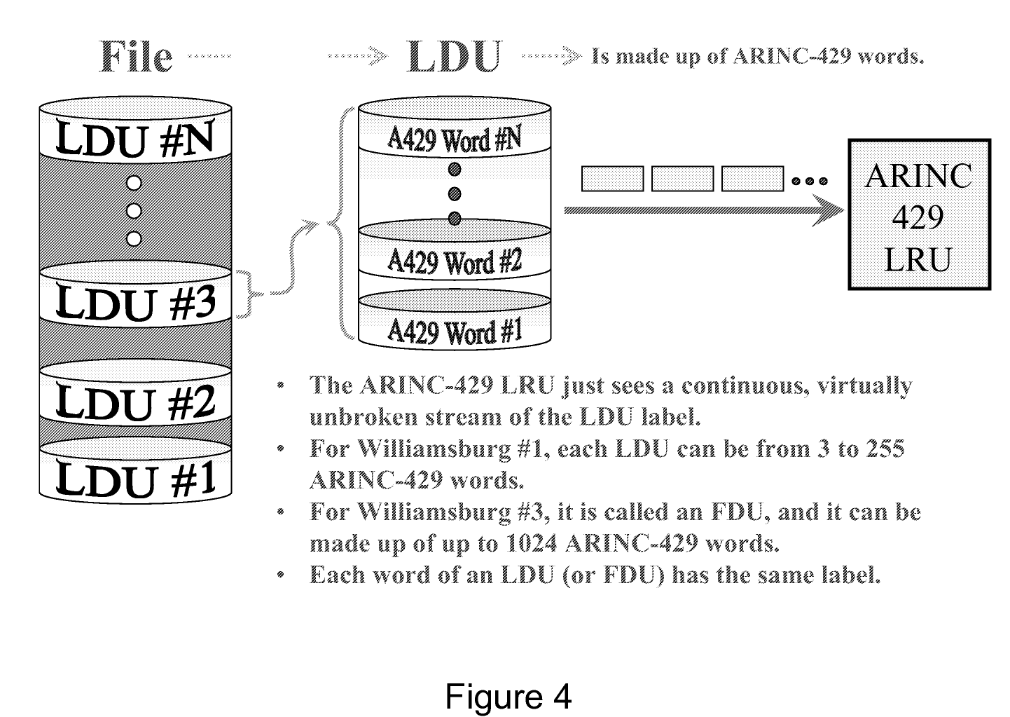

FIG. 3 illustrates one possible file segmentation scheme in accordance with an embodiment of the present invention. FIG. 4 illustrates another example of segmenting a file into multiple Ethernet or AFDX messages. The sizing is based on the periodicity of the Ethernet or AFDX messages and on the size of the buffer 36 or memory of the Ethernet to ARINC 429 converter 32.

In one embodiment, the initial Ethernet or AFDX message may only transmit sufficient data so as to guarantee that the buffer 36 of the Ethernet to ARINC 429 converter 32 does not run out of ARINC 429 words due to the asynchronous nature of the Ethernet or AFDX bus. In one embodiment, for example, the initial message contains more data than would be transmitted between successive AFDX messages, while leaving sufficient room in the buffer for subsequent messages. In other embodiments, the initial message may contain a similar amount of data as subsequent messages. In still other embodiments, the initial message may be smaller than subsequent messages. In yet other embodiments, the message sizes may vary from message to message and from file to file. While it is preferred that the message sizing and transmit rate be selected to prevent the buffer 36 of the Ethernet to ARINC 429 converter 32 from running out of data, in some embodiments, the buffer 36 can run out of data for short time periods as long as the entire file is received at the ARINC 429 device before the associated timer expires or runs out.

Based on the rate of ARINC 429 transmission and the scheduled rate of the Ethernet or AFDX transmissions, the subsequent data block sizes may be calculated for the next Ethernet or AFDX transmission. In embodiments where transmissions are not scheduled, the Ethernet to ARINC 429 converter 32 may send a buffer status message to the Ethernet device 20 that the buffer 36 has room for data. This status message may contain a symbol that represents the amount or number of bits, bytes, words, etc. available, the amount or number of bits, bytes, words, etc. used, a percentage of the memory available, a percentage of the memory used, a percentage range of the memory available, a percentage range of the memory used, etc. The Ethernet device 20 could then set the size and/or priority of the next message based on this status message.

In one embodiment, the software 22 reassembles a Williamsburg data block that is received over multiple Ethernet or AFDX messages from the Ethernet to ARINC 429 converter 32 or RDC. The size of the data within each Ethernet or AFDX message may be limited to the number of ARINC 429 words that are received within the transmit period of the, the Ethernet to ARINC 429 converter 32 or RDC onto the Ethernet or AFDX bus. This approach reduces the size of the buffer 38 required in the Ethernet to ARINC 429 converter 32. In embodiments using a larger buffer 38, the Ethernet or AFDX message may only be limited by the size of the buffer 38 and may be transmitted when the buffer 38 reaches a predetermined capacity, after a predetermined time, or after a predetermined time without receiving data.

In summary, numerous benefits are described which result from employing the concepts of the invention. The foregoing description of exemplary embodiments of the invention is presented for the purposes of illustration and description. It is not intended to be exhaustive or to limit the invention to the precise form disclosed. It will be appreciated that modifications or variations are possible in light of the above teachings. The above-described embodiments were selected and described in order to best illustrate the principles of the invention and its practical application to thereby enable one of ordinary skill in the art to best utilize the invention in various embodiments and with various modifications as are suited to particular uses contemplated. It is intended that the scope of the invention be defined by the claims appended hereto.

We claim:

1. A method for transmitting data between a first device connected to a first data bus having a first communication protocol and a second device connected to a second data bus having a second communication protocol, the method comprising:
receiving a block of data;
dividing the block of data into at least a first packet having a first packet size and a second packet having a second packet size;
transmitting the first packet to a converter, the converter being configured to convert a packet from the first communication protocol to the second communication protocol; and
transmitting the second packet to the converter after waiting a predetermined time,
wherein the first packet size, the second packet size, and the predetermined time are selected to prevent overflow of a memory of the converter, and
wherein the second packet size, and the predetermined time are selected to prevent expiration of a timer at the second data bus, the time being associated with data transferred in the first and second packets.

2. The method of claim 1, wherein the first data bus is an Ethernet network and the second data bus is an ARINC 429 bus, and
wherein the Ethernet network and ARINC 429 bus operate asynchronously.

3. The method of claim 1, wherein the first packet size is different than the second packet size.

4. The method of claim 3, wherein the first packet size is larger than the second packet size.

5. The method of claim 1, wherein the converter comprises an Ethernet to ARINC 429 data converter, and
wherein the second packet size, and the predetermined time are selected to prevent the buffer or memory of the Ethernet to ARINC 429 data converter from becoming empty while the block of data is being transferred.

6. The method of claim 1, wherein the predetermined time is variable.

7. The method of claim 1, wherein the converter comprises an Ethernet to ARINC 429 data converter, and
wherein the predetermined time is fixed for the Ethernet to ARINC 429 data converter

8. The method of claim 1, further comprising:
transmitting the received block of data to the converter, if a size of the block of data is smaller than a predetermined size.

9. A device for transmitting data between a first device connected to a first data bus having a first communication protocol and a second device connected to a second data bus having a second communication protocol, the device comprising:
a receiver means for receiving a block of data;
a dividing means for dividing the block of data into at least a first packet and a second packet, the first packet having a first packet size and the second packet having a second packet size;
a transmitting means for transmitting the first packet to a converter, the converter being configured to convert a packet from the first communication protocol to the second communication protocol; and
a transmitting means for transmitting the second packet to the converter after waiting a predetermined time,
wherein the first packet size, the second packet size, and the predetermined time are selected to prevent buffer or memory overflow at the data converter,
wherein the second packet size, and the predetermined time are selected to prevent expiration of a timer at the second device, and
wherein the timer is associated with data transferred in the first and second packets.

10. The device of claim 9, wherein the first data bus is an Ethernet network and the second data bus is an ARINC 429 bus, and
wherein the Ethernet and ARINC 429 buses operate asynchronously.

11. The device of claim 9, wherein the first packet size is different than the second packet size.

12. The device of claim 11, wherein the first packet size is larger than the second packet size.

13. The device of claim 8, wherein the second packet size, and the predetermined time are selected to prevent the buffer or memory of the data converter from becoming empty while the block of data is being transferred.

14. The device of claim 9, wherein the predetermined time is variable.

15. The device of claim 9, wherein the predetermined time is fixed for the data converter

16. A method for transmitting data between a first device connected to a first data bus having a first communication protocol and second and third devices connected to a second data bus having a second communication protocol, the method comprising:
receiving a first block of data addressed to the second device;
receiving a second block of data addressed to the third device;
dividing the first block of data into packets, the packets comprising at least a first packet and a second packet, the first packet having a first packet size and the second packet having a second packet size;
dividing the second block of data into packets, the packets comprising at least a third packet and a fourth packet, the third packet having a third packet size and the fourth packet having a fourth packet size;
transmitting the first packet addressed to the second device to a first converter, the first converter being configured to convert packets from the first communication protocol to the second communication protocol;
transmitting the third packet addressed to the third device to a second converter, the second converter being configured to convert packets from the first communication protocol to the second communication protocol;
transmitting the second packet addressed to the second device to the first converter after waiting a first predetermined time, and
transmitting the fourth packet addressed to the third device to the second converter after waiting a second predetermined time,
wherein the first packet size, the second packet size, and the first predetermined time are selected to prevent buffer or memory overflow at the first converter,
wherein the second packet size, and the first predetermined time are selected to prevent expiration of a first timer at the second device,
wherein the first timer is associated with data transferred in the first and second packets,
wherein the third packet size, the fourth packet size, and the second predetermined time are selected to prevent buffer or memory overflow at the second converter,
wherein the fourth packet size, and the second predetermined time are selected to prevent expiration of a second timer and the third device, and
wherein the second time is associated with data transferred in the third and fourth packets.

17. The method of claim 16, wherein the first and second predetermined times are different.

18. The of claim 17, wherein the first predetermined time is fixed for the first converter.

19. The method of claim 18, wherein the second predetermined time is fixed for the second converter.

20. The method of claim 16, wherein the first predetermined time is variable for the first converter.
